(19) United States
(12) Patent Application Publication
(10) Pub. No.: US 2026/0351915 A1
(43) Pub. Date: Nov. 5, 2026

(54) TERMINAL CRIMPING DEVICE

(71) Applicant: Shinmaywa Industries, Ltd., Takarazuka-shi, Hyogo (JP)

(72) Inventor: Masaru HISANO, Takarazuka-shi (JP)

(21) Appl. No.: 19/099,887

(22) PCT Filed: Aug. 3, 2022
(86) PCT No.: PCT/JP2022/029860

§ 371 Date: Jan. 30, 2025

(51) Int. Cl. H01R 43/052; B21D 39/04

(52) U.S. Cl. CPC H01R 43/052; B21D 39/04

(57) ABSTRACT

A terminal crimping device 8 includes a gripping device 3F gripping an electric cable 5; a crimper 4F including a press member 42F and an actuator 43F driving the press member 42F, the crimper 4F crimping a terminal 7 onto the electric cable 5, gripped by the gripping device 3F, by use of the press member 42; a moving device 6F moving the gripping device 3F in a crossing direction crossing a longitudinal direction of the electric cable 5; and a controller 9 controlling the gripping device 3F, the crimper 4F and the moving device 6F. The controller 9 includes a first controller 91 and a second controller 92. The first controller 91 controls the actuator 43F to crimp the terminal 7 onto the electric cable 5. The second controller 92 drives the moving device 6F to move the gripping device 3F in the crossing direction during a time period after the press member 42F contacts the terminal 7 until the press member 42F reaches a target position under the control of the first controller 91.

### TECHNICAL FIELD

The present invention relates to a terminal crimping device.

### BACKGROUND ART

Conventionally, an electric cable having a terminal crimped thereon is used as a component of a wire harness or the like. At the time of having the terminal crimped, the electric cable is locally expanded in a longitudinal direction. If, at this point, the electric cable is gripped so as not to be moved, a portion of the electric cable may undesirably be buckled because the movement of the electric cable in the longitudinal direction is restricted.

Patent Literature 1 discloses a crimping device that moves a feeding device for an electric cable along an axial direction of the electric cable during the crimping process in order to compensate for elongation of the electric cable occurring as a result of the plastic deformation thereof caused during the crimping.

Patent Literature 2 discloses a crimping device that causes a gripping device to release the electric cable before the completion of the crimping in order to allow the electric cable to extrude during the crimping.

### CITATION LIST

### Patent Literature

Patent Literature 1: Japanese Laid-Open Patent Publication No. 2015-211039

Patent Literature 2: Japanese PCT National-Phase Laid-Open Patent Publication No. 2017-518619

### SUMMARY OF INVENTION

### Technical Problem

With the method described in Patent Literature 1, the variance in the elongation of the electric cable among cycles of crimping cannot be dealt with, and the elongation of the electric cable can be absorbed merely roughly, or alternatively, the electric cable is forcibly pulled. With the method described in Patent Literature 2, the electric cable is released during the crimping, and therefore, may be positionally shifted.

The present invention provides a terminal crimping device suppressing an influence of elongation of an electric cable caused by crimping of a terminal and thus crimping the terminal onto the electric cable at higher quality.

### Solution to Problem

A terminal crimping device according to the present invention includes a gripping device gripping an electric cable; a crimper including a press member and an actuator driving the press member, the crimper crimping a terminal onto the electric cable, gripped by the gripping device, by use of the press member; a moving device moving the gripping device in a crossing direction crossing a longitudinal direction of the electric cable; and a controller controlling the gripping device, the crimper and the moving device. The controller includes a first controller and a second controller. The first controller controls the actuator to crimp the terminal onto the electric cable. The second controller drives the moving device to move the gripping device in the crossing direction during a time period after the press member contacts the terminal until the press member reaches a target position under the control of the first controller.

With the above-described terminal crimping device, the gripping device for the electric cable is moved in the crossing direction crossing the longitudinal direction of the electric cable during the time period after the press member contacts the terminal until the press member reaches the target position. Such a movement of the gripping device in the crossing direction absorbs elongation of the electric cable caused by the crimping. At this point, the electric cable is not released, and therefore, is suppressed from being positionally shifted. In addition, as compared with in the case where the gripping device is moved in the longitudinal direction of the electric cable to absorb the elongation of the electric cable, in the case where the gripping device is moved in the crossing direction to absorb the elongation of the electric cable, the degree of freedom of the electric cable is higher. Therefore, the distance of the movement of the gripping device may be caused to better follow the amount of the elongation of the electric cable caused by the crimping. As a result, the crimping of the terminal onto the electric cable may be performed at higher quality.

According to one preferred embodiment of the present invention, the crossing direction is substantially parallel to a driving direction of the press member.

The electric cable is elongated by the crimping, and therefore, easily receives a force of bending the electric cable in a direction substantially parallel to the driving direction of the press member. For this reason, with the above-described embodiment, the elongation of the electric cable caused by the crimping may be absorbed with more certainty.

According to one preferred embodiment of the terminal crimping device, the crossing direction is an upward direction or a downward direction. In this case, the driving direction of the press member is an up-down direction. The driving direction of the press member is the up-down direction, so that an area in which the terminal crimping device is installed may be made smaller.

According to one preferred embodiment of the terminal crimping device, where a direction in which the press member gets closer to the electric cable and the terminal is an approaching direction, the moving device is capable of moving the gripping device to a first position and to a second position set to be further in the approaching direction than the first position. The controller includes a third controller moving the gripping device from the first position to the second position along with the movement of the press member in the approaching direction under the control of the first controller. The second controller drives the moving device to move the gripping device from the second position to the first position during the time period after the press member contacts the terminal until the press member reaches the target position under the control of the first controller.

With the above-described embodiment, the gripping device is moved from the first position to the second along with the movement of the press member in the approaching direction, so that the electric cable may be suppressed from having an excessive load imposed thereon by the crimping. In addition, the gripping device is moved from the second position to the first position during the time period after the press member contacts the terminal until the press member reaches the target position, so that the elongation of the electric cable caused by the crimping may be absorbed.

According to another preferred embodiment of the terminal crimping device, the moving device is capable of moving the gripping device to a first position, to an intermediate position set to be further in the approaching direction than the first position, and to a second position set to be further in the approaching direction than the intermediate position. The controller includes a third controller moving the gripping device from the first position to the second position along with the movement of the press member in the approaching direction under the control of the first controller. The second controller drives the moving device to move the gripping device from the second position to the intermediate position during the time period after the press member contacts the terminal until the press member reaches the target position under the control of the first controller.

With the above-described embodiment, the gripping device reaches the intermediate position before the press member reaches the target position. Therefore, the moving time of the gripping device that is required to proceed to the next step may be shortened.

According to another preferred embodiment of the present invention, the moving device is capable of putting the gripping device into a state of being movable in the crossing direction. The controller includes a fourth controller driving the moving device to put the gripping device into a state of being movable in the crossing direction during a time period after the gripping device is moved in the crossing direction under the control of the second controller until the press member reaches the target position.

With the above-described embodiment, the gripping device is put into a state of being movable in the crossing direction during the time period after the gripping device is moved in the crossing direction until the press member reaches the target position, so that the moving distance of the gripping device may be caused to precisely follow the amount of the elongation of the electric cable caused by the crimping.

According to one preferred embodiment of the present invention, the first controller stops the press member temporarily during the time period after the press member contacts the terminal until the press member reaches the target position. The second controller moves the gripping device in the crossing direction while the press member is at a temporary stop.

With the above-described embodiment, the gripping device is moved while the press member is at a temporary stop. Therefore, it is easy to perform the control to match the timing at which the press member is moved and the timing at which the gripping device is moved.

### Advantageous Effects of Invention

According to the present invention, an influence of elongation of an electric cable caused by crimping of a terminal is suppressed and thus the terminal is crimped onto the electric cable at higher quality.

### BRIEF DESCRIPTION OF DRAWINGS

FIG. 1 is a plan view schematically showing a configuration of an electric cable processing apparatus.

FIG. 2 is a side view of an F-side clamp.

FIG. 3A is a front view of a crimper showing a state before a press member starts terminal crimping.

FIG. 3B is a front view of the crimper showing a state where the press member has finished the terminal crimping.

FIG. 4 is a block diagram of a terminal crimping device.

FIG. 5 is a flowchart of the terminal crimping.

FIG. 6 is a side view of an electric cable showing a movement thereof at the time of the terminal crimping.

FIG. 7 is a flowchart of terminal crimping in embodiment 2.

FIG. 8 is a side view showing a movement of the electric cable at the time of the terminal crimping in embodiment 2.

FIG. 9 is a block diagram of a terminal crimping device in embodiment 3.

FIG. 10 is a flowchart of terminal crimping in embodiment 3.

FIG. 11 is a side view showing a movement of the electric cable at the time of the terminal crimping in embodiment 3.

### DESCRIPTION OF EMBODIMENTS

### Embodiment 1

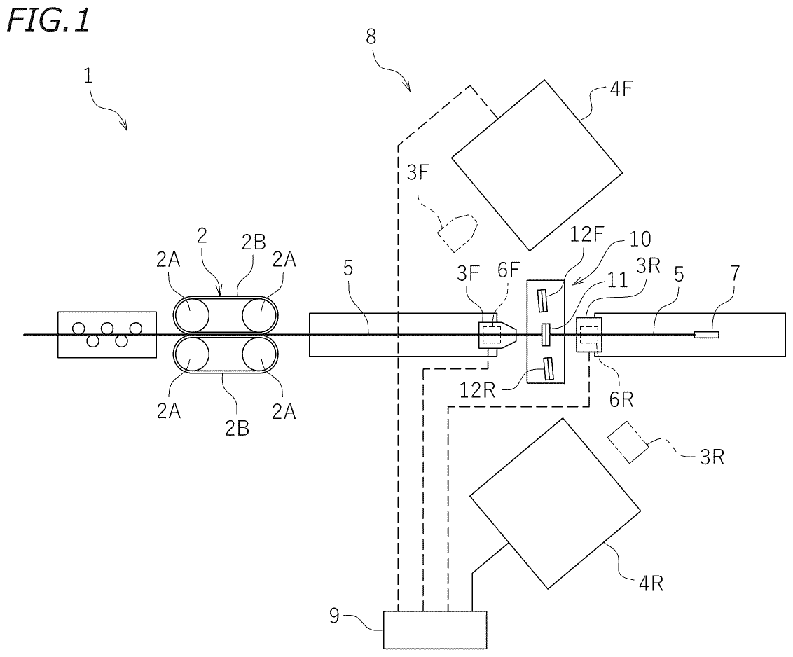

Hereinafter, embodiments of the present invention will be described. FIG. 1 is a plan view schematically showing a configuration of an electric cable processing apparatus 1 including a terminal crimping device 8 according to one embodiment. In the following description, the right side and the left side in FIG. 1 will respectively be defined as the front side and the rear side. The top side and the bottom side in FIG. 1 will respectively be defined as the left side and the right side. Note that these directions are merely defined for the sake of convenience, and do not limit, for example, the position at which a terminal crimping device according to the present invention is installed in any way.

The electric cable processing apparatus 1 includes a feeding device 2 feeding an electric cable 5, a clamp 3F sandwiching a front end portion of the electric cable 5 fed by the feeding device 2, an elevation device 6F moving the clamp 3F in a direction crossing a longitudinal direction of the electric cable 5, that is, in this embodiment, an up-down direction, a crimper 4F crimping a terminal 7 onto the front end portion of the electric cable 5 sandwiched by the clamp 3F, a cutter device 10, a clamp 3R sandwiching a rear end portion of the electric cable 5 located to the front of the cutter device 10, an elevation device 6R moving the clamp 3R in the up-down direction, and a crimper 4R crimping a terminal 7 onto the rear end portion of the electric cable 5 sandwiched by the clamp 3R. The clamp 3F and the clamp 3R are respectively to sandwich the front end portion of the electric cable 5 and the rear end portion of the electric cable 5, and therefore, may respectively be referred to as the “F-side (front-side) clamp” and the “R-side (rear-side) clamp” as appropriate, hereinafter. The clamp 3F and the clamp 3R are each an example of gripping device gripping the electric cable 5. The elevation devices 6F and 6R are respectively to move the F-side clamp 3F and the R-side clamp 3R in the up-down direction, and therefore, may respectively be referred to as the “F-side (front-side) elevation device” and the “R-side (rear-side) elevation device” as appropriate, hereinafter. The crimper 4F and the crimper 4R are respectively to crimp the terminals 7 onto the front end portion of the electric cable 5 and the rear end portion of the electric cable 5, and therefore, will respectively be referred to as the “F-side (front-side) crimper” and the “R-side (rear-side) crimper” as appropriate, hereinafter.

There is no specific limitation on the configuration of the feeding device 2. In this embodiment, the feeding device 2 includes a pair of pulleys 2A located at a front position and a rear position and a transportation belt 2B wound along the pulleys 2A. Such a set of the pair of pulleys 2A and the transportation belt 2B is provided on the left side, and another set of the pair of pulleys 2A and the transportation belt 2B is provided on the right side. Although not shown, a motor is coupled to at least one of the pair of pulleys 2A. The motors are driven to rotate the pulleys 2A, and as a result, the transportation belts 2B circulate. This causes the electric cable 5 sandwiched by the left and right transportation belts 2B to be fed forward.

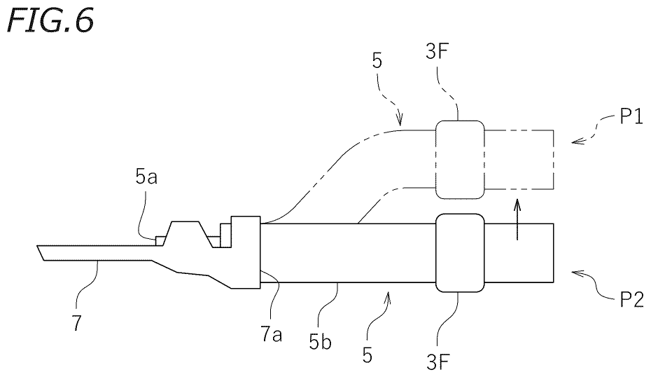

The electric cable 5 is a so-called covered electric cable, and includes a core wire 5a formed of a conductor of a metal material or the like and an insulating member 5b enclosing the core wire 5a and formed of a resin or the like (see FIG. 6). The cutter device 10 includes a cutting blade 11 cutting the electric cable 5, a stripping blade 12F stripping the front end portion of the insulating member 5b of the electric cable 5 sandwiched by the F-side clamp 3F, and a stripping blade 12R striping the rear end portion of the insulating member 5b of the electric cable 5 sandwiched by the R-side clamp 3R.

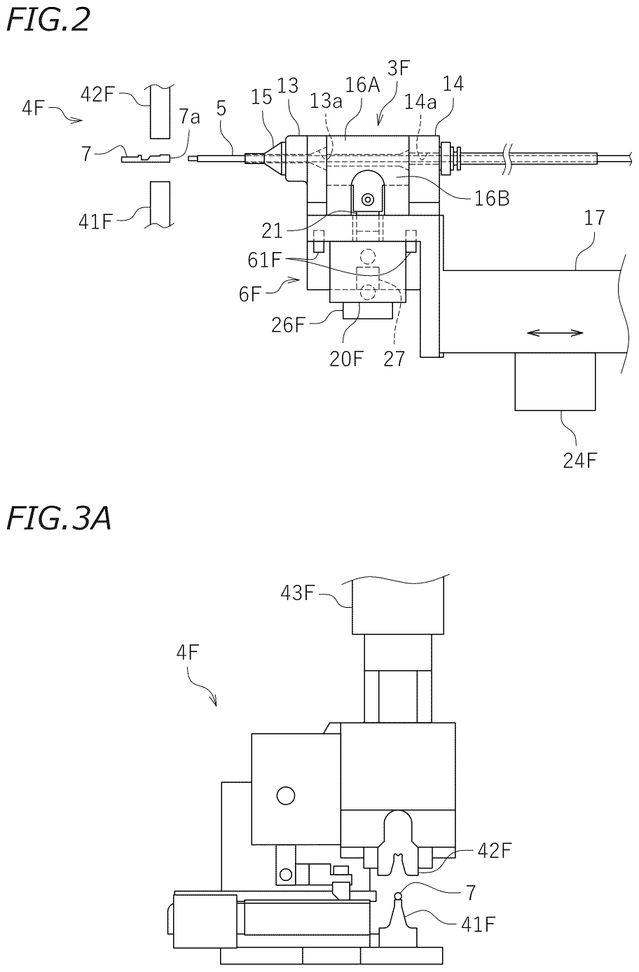

FIG. 2 is a side view of the F-side clamp 3F. As shown in FIG. 2, the F-side clamp 3F includes a front wall 13 having a hole 13a formed therein, a rear wall 14 having a hole 14a formed therein, a first block 16A located between the front wall 13 and the rear wall 14, a second block 16B located below the first block 16A, and a nozzle 15 extending forward from the front wall 13. The second block 16B is movable in the up-down direction, and is capable of getting closer to, or farther from, the first block 16A. The second block 16B is connected with a rod 21 of an air cylinder 20F. The rod 21 of the air cylinder 20F is extendable and contractable by a solenoid valve 22F (see FIG. 4) being switched. The solenoid valve 22F is switched to extend or contract the rod 21, and as a result, the second block 16B gets closer to, or farther from, the first block 16A. When the second block 16B gets closer to the first block 16A, the first block 16A and the second block 16B sandwich the electric cable 5. When the second block 16B gets farther from the first block 16A, the sandwiching of the electric cable 5 by the first block 16A and the second block 16B is cancelled. The electric cable 5 is transported forward through the hole 14a of the rear wall 14, between the first block 16A and the second block 16B, through the hole 13a of the front wall 13, and through the nozzle 15.

As shown in FIG. 2, the F-side clamp 3F is supported by a guide member 17, and the guide member 17 is coupled with a movement actuator 24F. The movement actuator 24F is capable of moving the F-side clamp 3F in a front-rear direction. The movement actuator 24F is not limited to having any specific configuration, and may be any known actuator such as a motor or the like.

As shown in FIG. 2, the F-side elevation device 6F supports the F-side clamp 3F from below. The F-side elevation device 6F moves the F-side clamp 3F in the up-down direction. In this embodiment, a direction in which a press member 42F of the F-side crimper 4F moves is the up-down direction, and the direction in which the F-side elevation device 6F moves the F-side clamp 3F is substantially parallel to a driving direction in which the press member 42F is driven. In the case where the press member 42F moves in a different direction, the F-side elevation device 6F may move the F-side clamp 3F in a direction substantially parallel to such a different direction.

The F-side elevation device 6F includes guide rails 61F and an air cylinder 26F. The guide rails 61F extend in the up-down direction. The F-side clamp 3F is in slidable engagement with the guide rails 61F. The air cylinder 26F includes a rod 27 extendable and contractable in the up-down direction. The rod 27 of the air cylinder 26F extends and contracts by a solenoid valve 28F (see FIG. 4) being switched. The solenoid valve 28F is switched to extend or contract the rod 27, and as a result, the F-side clamp 3F moves in the up-down direction along the guide rails 61F. In this embodiment, the F-side elevation device 6F is capable of moving the F-side clamp 3F to a top position P1 (see FIG. 6) and to a bottom position P2 (see FIG. 6) set to be below the top position P1 (set to be further in a direction in which the press member 42F gets closer to the electric cable 5 and the terminal 7 for the crimping than the top position P1).

The R-side clamp 3R and the R-side elevation device 6R may respectively have the same configurations as those of the F-side clamp 3F and the F-side elevation device 6F. Note that either one of, or both of, the R-side clamp 3R and the R-side elevation device 6R may have a configuration(s) different from that (those) of the F-side clamp 3F or/and the F-side elevation device 6F. Each of the F-side clamp 3F and the R-side clamp 3R is not limited to having any specific configuration as long as gripping the electric cable 5. Each of the F-side elevation device 6F and the R-side elevation device 6R is not limited to having any specific configuration as long as moving the F-side clamp 3F or the R-side clamp 3R in a direction crossing the longitudinal direction of the electric cable 5. Preferably, the F-side elevation device 6F and the R-side elevation device 6R respectively move the F-side clamp 3F and the R-side clamp 3R in a direction perpendicularly crossing the longitudinal direction of the electric cable 5.

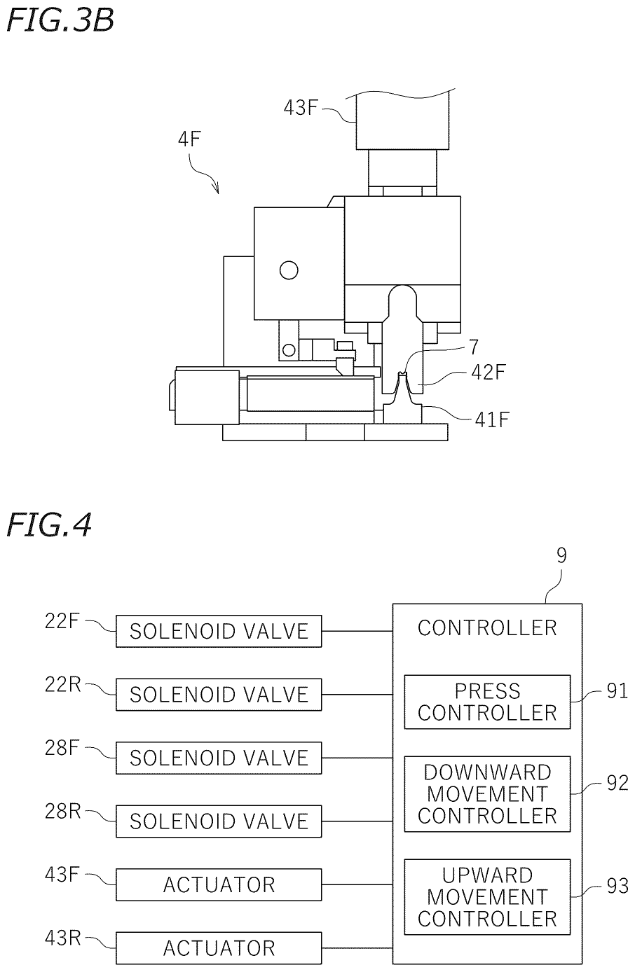

The F-side crimper 4F and the R-side crimper 4R have the same configuration as each other. Herein, the F-side crimper 4F will be described, whereas the description on the R-side crimper 4R will be omitted. The F-side crimper 4F includes the press member 42F and an actuator 43F driving the press member 42F, and crimps the terminal 7 onto the electric cable 5, sandwiched by the F-side clamp 3F, by use of the press member 42F. FIG. 3A is a front view of the F-side crimper 4F, and shows a state where the press member 42F is at a highest position. FIG. 3B shows a state where the press member 42F is at a lowest position. FIG. 3A shows a state before the press member 42F starts the terminal crimping, whereas FIG. 3B shows a state where the press member 42F has finished the terminal crimping. As shown in FIG. 3A and FIG. 3B, the crimper 4F includes an anvil 41F supporting the terminal 7 and the press member 42F, which is capable of getting closer to, and farther from, the anvil 41F. In this embodiment, the press member 42F is movable in the up-down direction. The press member 42F is a press that strikes the terminal 7 onto an end portion of the electric cable 5 to put the terminal 7 into close contact with the end portion of the electric cable 5. The actuator 43F moves the press member 42F in the up-down direction. The actuator 43F is not limited to having any specific configuration, and may be any known actuator such as a hydraulic press or the like.

As shown in FIG. 1, the terminal crimping device 8 includes a controller 9 controlling the clamps 3F and 3R, the crimpers 4F and 4R, and the elevation devices 6F and 6R. FIG. 4 is a block diagram of the terminal crimping device 8. As shown in FIG. 4, the terminal crimping device 8 is connected with the solenoid valve 22F of the F-side clamp 3F, a solenoid valve 22R of the R-side clamp 3R, the solenoid valve 28F of the F-side elevation device 6F, a solenoid valve 28R of the R-side elevation device 6R, the actuator 43F of the F-side crimper 4F, and an actuator 43R of the R-side crimper 4R, and controls operations thereof. In this embodiment, the controller 9 is formed of a computer, and includes a CPU, a ROM, a RAM and the like. The controller 9 may be a computer dedicated for use in the terminal crimping device 8 or may be a general-purpose computer such as a personal computer or the like. The controller 9 includes, as controllers involved in the crimping of the terminal 7, a press controller 91, a downward movement controller 92, and an upward movement controller 93. The controller 9 may include another controller, but such a controller will not be shown or described herein.

The press controller 91 controls the actuator 43F of the crimpers 4F and 4R to crimp the terminal 7 onto the electric cable 5. For crimping the terminal 7, the press controller 91 drives the press member 42F downward. The downward movement controller 92 moves the F-side clamp 3F from the top position P1 to the bottom position P2 along with the downward movement of the press member 42F performed under the control of the press controller 91. The upward movement controller 93 drives the F-side elevation device 6F to move the F-side clamp 3F upward during the time period after the press member 42F contacts the terminal 7 until the press member 42F reaches a target position under the control of the press controller 91. In more detail, the upward movement controller 93 drives the F-side elevation device 6F to move the F-side clamp 3F from the bottom position P2 to the top position P1 during the time period after the press member 42F contacts the terminal 7 until the press member 42F reaches the target position under the control of the press controller 91. The press controller 91, the downward movement controller 92 and the upward movement controller 93 perform the same controls on the R-side clamp 3R, the R-side crimper 4R and the R-side elevation device 6R. Herein, the “target position” is a lowest point that the press member 42F reaches to crimp the terminal 7, and may be referred to also as the “lowest point”, hereinafter. In the case where the press member 42F moves in a direction other than the downward direction for crimping the terminal 7, the target position may be a position most ahead in the moving direction of the press member 42F. In the following, “moving the press member 42F to the target position” may be expressed also as “moving the press member 42F to the end”.

Now, an operation of the electric cable processing apparatus 1 will be described. First, the electric cable 5 is fed forward (rightward in FIG. 1) by the feeding device 2. Next, the electric cable 5 is sandwiched by the F-side clamp 3F and the R-side clamp 3R and then is cut by the cutting blade 11 of the cutter device 10.

Next, the F-side clamp 3F is swung leftward (upward in FIG. 1) while sandwiching the post-cutting electric cable 5 to carry the front end portion of the electric cable 5 to the stripping blade 12F. The R-side clamp 3R is swung rightward (downward in FIG. 1) while sandwiching the electric cable 5 to carry the rear end portion of the post-cutting electric cables 5 to the stripping blade 12R. The end portions of both of the electric cables 5 are stripped of the insulating members by the stripping blades 12F and 12R.

Then, the F-side clamp 3F is further swung leftward while sandwiching the electric cable 5 to carry the front end portion of the electric cable 5 such that the front end portion faces the F-side crimper 4F as represented by the phantom line in FIG. 1. The R-side clamp 3R is further swung rightward while sandwiching the electric cable 5 to carry the rear end portion of the electric cable 5 such that the rear end portion faces the R-side crimper 4R as represented by the phantom line in FIG. 1. The terminals 7 are respectively crimped to the end portions of the electric cables 5 by the crimpers 4F and 4R. The operation of the terminal crimping will be described below in detail.

Next, the F-side clamp 3F returns to an initial position thereof (the position represented by the solid line in FIG. 1) facing the cutting blade 11 while sandwiching the electric cable 5 having the terminal 7 crimpled thereon, and cancels the sandwiching of the electric cable 5. That is, the F-side clamp 3F releases the electric cable 5. The R-side clamp 3R releases the electric cable 5 having the terminal 7 crimpled thereon, and then returns to an initial position thereof (the position represented by the solid line in FIG. 1) facing the cutting blade 11. The electric cable released by the R-side clamp 3R (the electric cable having the terminals 7 crimped on both of two end portions thereof) is dropped and recovered by a tray (not shown). After this, the above-described operations are repeated. As a result, the electric cables 5 each having the terminals 7 crimped on both of the two end portions thereof are produced one after another.

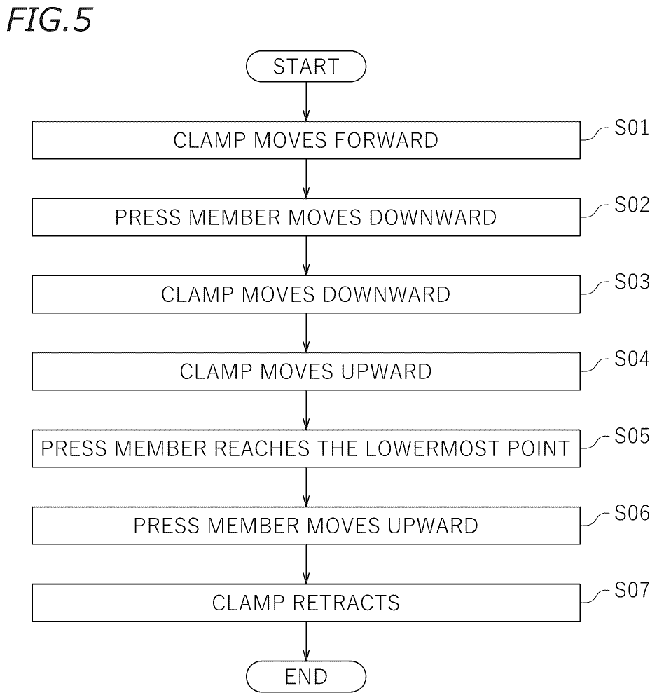

Now, a terminal crimping method will be described in detail. Herein, the method will be described regarding F-side terminal crimping as an example. R-side terminal crimping is performed in the same manner. Note that the F-side terminal crimping and the R-side terminal crimping do not need to be performed in the same manner. FIG. 5 is a flow chart of the terminal crimping. As shown in FIG. 5, for the F-side terminal crimping, the F-side clamp 3F moves to a position facing the crimper 4F (not shown), and then moves forward while sandwiching the electric cable 5 until the end portion of the electric cable 5 overlaps the terminal 7 (step S01). In step S01, the F-side clamp 3F moves forward until the end portion of the electric cable 5 is inserted into an insertion portion 7a (see FIG. 6) of the terminal 7. At this point, the F-side clamp 3F is located at the top position P1. Note that the electric cable 5 may be moved to a position above the terminal 7 from a position to the side of the terminal 7 by, for example, moving in a transverse direction or swinging. In this embodiment, the terminal 7 is a so-called open barrel terminal, and the electric cable 5 may be inserted into the terminal 7 from the opened side (in this embodiment, from above).

In step S02, the actuator 43F of the crimper 4F is driven and as a result, the press member 42 starts moving downward toward the anvil 41F. Step S03 is started at the same time as, immediately after, or immediately before, step S02. In step S03, the F-side clamp 3F moves from the top position P1 to the bottom position P2 along with the downward movement of the press member 42F. As a result, the electric cable 5 and the terminal 7 attached to the end portion of the electric cable 5 also move downward. When the F-side clamp 3F reaches the bottom position P2, the terminal 7 contacts the anvil 41F. When reaching a predetermined position after moving downward, the press member 42F contacts the terminal 7 on the anvil 41F and starts compressing the terminal 7.

In step S04, in a state where the terminal 7 is unmovably pressed by the press member 42F but the press member 42F has not yet completely compressed the terminal 7, the F-side elevation device 6F is driven and as a result, the F-side clamp 3F is returned to the top position P1. As a result, a portion of the electric cable 5 that is to the rear of the portion inserted into the terminal 7 is moved upward, without the terminal 7 or the end portion of the electric cable 5 moving.

FIG. 6 is a side view of the electric cable 5 showing a movement of the electric cable 5 in step S04. In FIG. 6, the F-side crimper 4F is omitted and the F-side clamp 3F is schematically shown for easy understanding. As shown in FIG. 6, the F-side clamp 3F moves upward, and as a result, the distance between the F-side clamp 3F (the portion of the electric cable 5 that is gripped by the F-side clamp 3F) and the terminal 7 (the end portion of the electric cable 5) is extended. If the electric cable 5 is not elongated by the terminal crimping, the electric cable 5 is pulled rearward by this movement. In actuality, during the crimping of the terminal 7, the electric cable 5 is compressed by the press member 42F and thus is gradually elongated. The F-side clamp 3F is moved upward during the crimping of the terminal 7 to gradually extend the distance between the F-side clamp 3F and the terminal 7 (the end portion of the electric cable 5). As a result, the elongation of the electric cable 5 is absorbed, and an influence of the elongation of the electric cable 5 is alleviated. If the elongation of the electric cable 5 is not absorbed, the electric cable 5 may undesirably be buckled by the elongation.

In step S05, the press member 42F is moved to the end, i.e., is moved downward to the lowest position. As a result, the terminal 7 is deformed until a portion of the terminal 7 sandwiches the end portion of the electric cable 5. Thus, the terminal 7 is put into close contact with the electric cable 5. In step S06, the press member 42F is moved upward and is separated from the terminal 7. In step S07, the electric cable 5 retracts, and the crimping process of the terminal 7 is finished.

Hereinafter, functions and effects provided by the terminal crimping device 8 according to this embodiment will be described. The terminal crimping device 8 according to this embodiment includes the clamp 3F gripping the electric cable 5, the crimper 4F crimping the terminal 7 onto the electric cable 5 gripped by the clamp 3F, the elevation device 6F as a moving device moving the clamp 3F in a crossing direction crossing the longitudinal direction of the electric cable 5, and the controller 9 controlling the clamp 3F, the crimper 4F and the elevation device 6F. The crimper 4F includes the press member 42F and the actuator 43F driving the press member 42F, and crimps the terminal 7 onto the electric cable 5, gripped by the clamp 3F, by use of the press member 42. The controller 9 includes the press controller 91 controlling the actuator 43F to crimp the terminal 7 onto the electric cable 5 and the upward movement controller 93 driving the elevation device 6F to move the clamp 3F in the crossing direction during the time period after the press member 42F contacts the terminal 7 until the press member 42F reaches the target position (in this embodiment, the lowest point) under the control of the press controller 91.

With the terminal crimping device 8 having the above-described configuration, the clamp 3F is moved in the crossing direction crossing the longitudinal direction of the electric cable 5 during the time period after the press member 42F contacts the terminal 7 until the press member 42F reaches the target position. Such a movement of the clamp 3F in the crossing direction absorbs the elongation of the electric cable 5 caused by the crimping. As a result, the electric cable 5 may be suppressed from being buckled by being elongated at the time of the crimping.

With the method described in Patent Literature 2, the electric cable is released during the crimping of the terminal. Therefore, the electric cable may be positionally shifted. By contrast, according to this embodiment, the electric cable 5 is not released during the crimping, and therefore, is suppressed from being positionally shifted. In addition, as compared with in the case where the clamp 3F is moved in the longitudinal direction of the electric cable 5 to absorb the elongation of the electric cable 5, in the case where the clamp 3F is moved in the crossing direction to absorb the elongation of the electric cable 5, the degree of freedom of the electric cable 5 is higher. Therefore, the distance of the movement of the clamp 3F may be caused to better follow the amount of the elongation of the electric cable 5 caused by the crimping. With the method described in Patent Literature 1, the gripping device for the electric cable is moved in the longitudinal direction of the electric cable to reduce the influence of the elongation of the electric cable. As such, the terminal crimping device 8 according to this embodiment may crimp the terminal 7 onto the electric cable 5 at higher quality than by the conventionally methods.

According to this embodiment, the direction in which the clamp 3F is moved is substantially parallel to the driving direction of the press member 42F. The electric cable 5 is elongated by the crimping, and therefore, easily receives a force of bending the electric cable 5 in a direction substantially parallel to the driving direction of the press member 42F. For this reason, the terminal crimping device 8 according to this embodiment may absorb, with certainty, the elongation of the electric cable 5 caused by the crimping. The direction “substantially parallel” to the driving direction of the press member 42F is, for example, a direction shifted by 10 degrees or less from the driving direction of the press member 42F. Note that the direction in which the clamp 3F is moved is not limited to any specific direction as long as crossing the longitudinal direction of the electric cable 5. The direction in which the clamp 3F is moved may be a direction perpendicular to the longitudinal direction of the electric cable 5, for example, a left-right direction or a direction oblique to the longitudinal direction of the electric cable 5.

According to this embodiment, the direction in which the clamp 3F is moved is the upward direction. The driving direction of the press member 42F is the up-down direction. The driving direction of the press member 42F is the up-down direction, so that an area in which the terminal crimping device 8 is installed may be made smaller. The direction in which the clamp 3F is moved may be the downward direction. The direction in which the clamp 3F is moved may be the same as the direction in which the press member 42F is moved at the time of crimping, or may be opposite to the direction in which the press member 42F is moved at the time of crimping. In the case where the driving direction of the press member 42F is the up-down direction, the direction in which the clamp 3F is moved is preferably the upward direction or the downward direction.

According to this embodiment, the elevation device 6F is capable of moving the clamp 3F to the top position P1 and to the bottom position P2 set to be below the top position P1. The controller 9 includes the downward movement controller 92 moving the clamp 3F from the top position P1 to the bottom position P2 along with the downward movement of the press member 42F performed under the control of the press controller 91. The upward movement controller 93 drives the elevation device 6F to move the clamp 3F from the bottom position P2 to the top position P1 during the time period after the press member 42F contacts the terminal 7 until the press member 42F reaches the target position under the control of the press controller 91. According to such a configuration, the clamp 3F is moved from the top position P1 to the bottom position P2 along with the downward movement of the press member 42F, so that the electric cable 5 may be suppressed from having an excessive load imposed thereon by the crimping. In addition, the clamp 3F is moved from the bottom position P2 to the top position P1 during the time period after the press member 42F contacts the terminal 7 until the press member 42F reaches the target position, so that the elongation of the electric cable 5 caused by the crimping may be absorbed. According to this embodiment, the post-terminal crimping electric cable 5 moved to the top position P1 is moved rearward while being kept at the top position P1. Therefore, the efficiency of the process is high.

As described above, the terminal crimping device 8 according to this embodiment may suppress the influence of the elongation of the electric cable 5 caused by the crimping of the terminal 7 and crimp the terminal 7 onto the electric cable 5 at higher quality.

### Embodiment 2

Embodiment 2 is different from embodiment 1 in the manner in which the clamps are moved during the terminal crimping. In the following description of embodiment 2, elements having the common functions to those in embodiment 1 will bear the common reference signs thereto, and overlapping descriptions thereof will be omitted or simplified as appropriate. This is also applicable to the other embodiments.

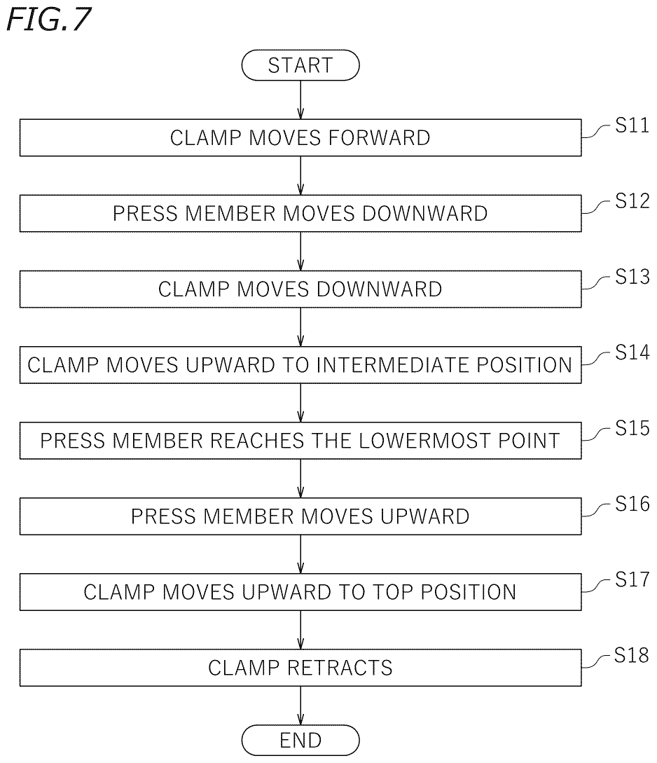

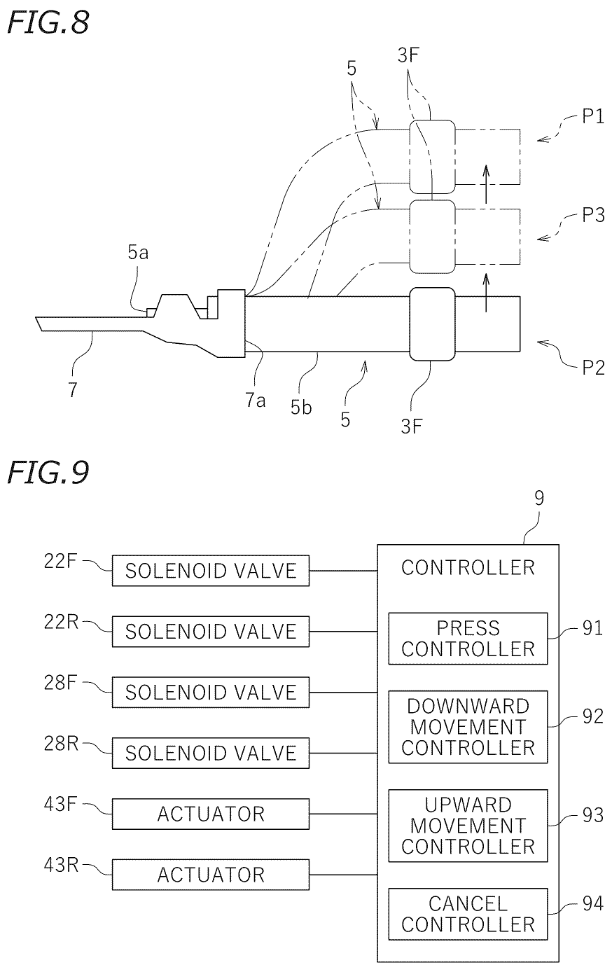

FIG. 7 is a flowchart of terminal crimping in embodiment 2. FIG. 8 is a side view showing a movement of the electric cable 5 at the time of the terminal crimping in embodiment 2. As shown in FIG. 8, in embodiment 2, the elevation device 6F is capable of moving the clamp 3F to the top position P1, to an intermediate position P3 set to be below the top position P1, and to the bottom position P2 set to be below the intermediate position P3. Therefore, the elevation device 6F may, for example, include two air cylinders.

As shown in FIG. 7, for the F-side terminal crimping in this embodiment, the F-side clamp 3F moves to a position facing the crimper 4F (not shown), and then moves forward while sandwiching the electric cable 5 until the end portion of the electric cable 5 overlaps the terminal 7 (step S11). The electric cable 5 may be moved to a position above the terminal 7 from a position to the side of the terminal, like in embodiment 1. At this point, the F-side clamp 3F is located at the top position P1. In step S12, the actuator 43F of the crimper 4F is driven and as a result, the press member 42F starts moving downward toward the anvil 41F. Steps S11 and S12 may respectively be the same as steps S01 and S02 in embodiment 1.

Step S13 is started at the same time as, immediately after, or immediately before, step S02. In step S13, the F-side clamp 3F moves from the top position P1 to the bottom position P2 along with the downward movement of the press member 42F. As a result, the electric cable 5 and the terminal 7 attached to the end portion of the electric cable 5 also move downward. When the F-side clamp 3F reaches the bottom position P2, the terminal 7 contacts the anvil 41F. When reaching a predetermined position after moving downward, the press member 42F contacts the terminal 7 on the anvil 41F and starts compressing the terminal 7.

In step S14, in a state where the terminal 7 is unmovably pressed by the press member 42F but the press member 42F has not yet completely compressed the terminal 7, the F-side elevation device 6F is driven and the F-side clamp 3F is moved to the intermediate position P3. As a result, a portion of the electric cable 5 that is to the rear of the portion inserted into the terminal 7 is moved upward, without the terminal 7 or the end portion of the electric cable 5 moving.

As shown in FIG. 8, the F-side clamp 3F moves to the intermediate position P3, and as a result, the distance between the F-side clamp 3F (the portion of the electric cable 5 that is gripped by the F-side clamp 3F) and the terminal 7 (the end portion of the electric cable 5) is extended, like in embodiment 1. As a result, the elongation of the electric cable 5 during the crimping of the terminal 7 is absorbed, and an influence of the elongation of the electric cable 5 is alleviated.

In step S15, the press member 42F is moved to the end, and the terminal 7 is put into close contact with the electric cable 5. In step S16, the press member 42F is moved upward and is separated from the terminal 7. In step S17, the clamp 3F is moved upward to the top position P1. In step S18, the electric cable 5 retracts, and the crimping process of the terminal 7 is finished.

In this embodiment, the downward movement controller 92 moves the clamp 3F from the top position P1 to the bottom position P2 along with the downward movement of the press member 42F performed under the control of the press controller 91. The upward movement controller 93 drives the elevation device 6F to move the clamp 3F from the bottom position P2 to the intermediate position P3 during the time period after the press member 42F contacts the terminal 7 until the press member 42F reaches the target position under the control of the press controller 91. According to such a configuration, the clamp 3F reaches the intermediate position P3 before the press member 42F reaches the target position. Therefore, the moving time of the clamp 3F that is required to proceed to the next step may be shortened. The R-side terminal crimping may be the same as the F-side terminal crimping.

### Embodiment 3

In embodiment 3, the clamp 3F is moved upward by a short distance in a state where the terminal 7 is unmovably pressed by the press member 42F, and then is made movable in the up-down direction. In this embodiment, the elevation device 6F is capable of putting the clamp 3F into a state of being movable in the up-down direction. For this purpose, the air cylinder 26F of the elevation device 6F may be, for example, of a type freely extendable and contractable when being supplied with no air. In this case, for putting the clamp 3F into a state of being movable in the up-down direction, the solenoid valve 28F is controlled to stop the supply of the air into the air cylinder 26F and discharge the air.

FIG. 9 is a block diagram of a terminal crimping device 8 according to embodiment 3. As shown in FIG. 9, the controller 9 of the terminal crimping device 8 according to embodiment 3 includes a cancel controller 94. The cancel controller 94 drives the elevation device 6F to put the clamp 3F into a state of being movable in the up-down direction during the time period after the clamp 3F is moved upward under the control of the upward movement controller 93 until the press member 42F reaches the target position.

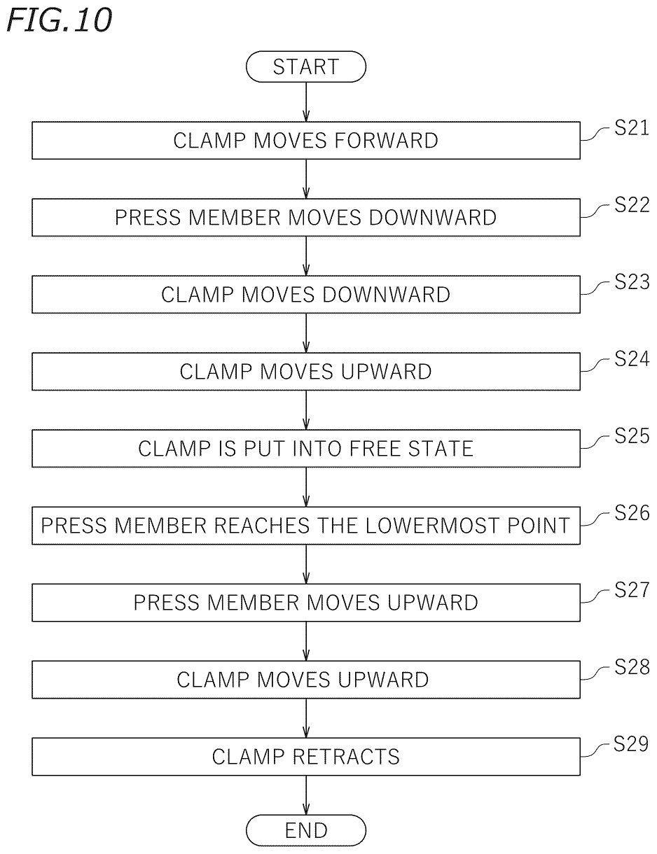

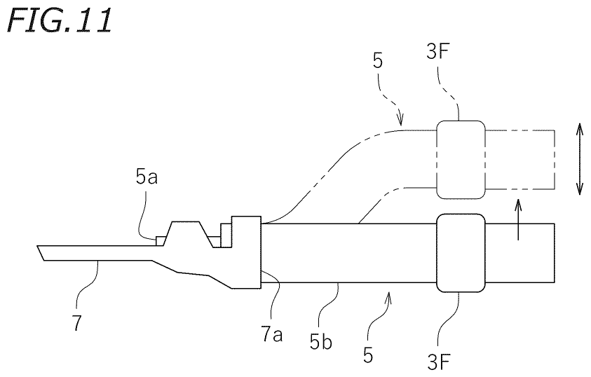

FIG. 10 is a flowchart of terminal crimping in embodiment 3. FIG. 11 is a side view showing a movement of the electric cable 5 at the time of the terminal crimping in embodiment 3. As shown in FIG. 10, for the F-side terminal crimping in this embodiment, the F-side clamp 3F moves to a position facing the crimper 4F (not shown), and then moves forward while sandwiching the electric cable 5 until the end portion of the electric cable 5 overlaps the terminal 7 (step S21). The electric cable 5 may be moved to a position above the terminal 7 from a position to the side of the terminal, like in embodiment 1 and embodiment 2. At this point, the F-side clamp 3F is located at the top position P1. In step S22, the actuator 43F of the crimper 4F is driven and as a result, the press member 42F starts moving downward toward the anvil 41F. Steps S21 and S22 may respectively be the same as steps S01 and S02 in embodiment 1.

Step S23 is started at the same time as, immediately after, or immediately before, step S02. In step S23, the F-side clamp 3F moves from the top position P1 to the bottom position P2 along with the downward movement of the press member 42F. As a result, the electric cable 5 and the terminal 7 attached to the end portion of the electric cable 5 also move downward. When the F-side clamp 3F reaches the bottom position P2, the terminal 7 contacts the anvil 41F. When reaching a predetermined position after moving downward, the press member 42F contacts the terminal 7 on the anvil 41F and starts compressing the terminal 7.

In step S24, in a state where the terminal 7 is unmovably pressed by the press member 42F but the press member 42F has not yet completely compressed the terminal 7, the F-side elevation device 6F is driven and as a result, the F-side clamp 3F is slightly moved upward. In step S25 following step S24, the clamp 3F is put into a state of being movable in the up-down direction (see the two-headed arrow in FIG. 11). Hereinafter, the state where the clamp 3F is movable in the up-down direction will also be referred to as the “free state”. The clamp 3F is put into the free state, so that the moving distance of the clamp 3F may be caused to precisely follow the amount of the elongation of the electric cable 5 caused by the terminal crimping. For example, in the case where the amount of the elongation of the electric cable 5 caused by the terminal crimping is larger, the clamp 3F moves upward by a longer distance. As a result, an influence of the elongation of the electric cable 5 may be further reduced.

In step S26, the press member 42F is moved to the end, and the terminal 7 is put into close contact with the electric cable 5. In step S27, the press member 42F is moved upward and is separated from the terminal 7. In step S28, the clamp 3F is moved to the top position P1. In step S29, the electric cable 5 retracts, and the crimping process of the terminal 7 is finished.

### Other Embodiments

Some embodiments of the present invention are described above. The above-described embodiments are merely examples, and the present invention may be carried out in any of various other embodiments. Hereinafter, examples of such other embodiments will be described.

During the time period after the press member 42F starts moving downward toward the anvil 41F until the press member 42F stops at the lowest point, the press member 42F may keep on moving downward or may stop temporarily in the middle. For example, the press member 42F may stop moving downward temporarily at a position where the press member 42F compresses the terminal 7 to a certain degree and then may move downward to the lowest point. The upward movement of the clamp 3F may be performed while the press member 42F is at a temporary stop. That is, the press controller 91 may stop the press member 42F temporarily during the time period after the press member 42F contacts the terminal 7 until the press member 42F reaches the target position, and the upward movement controller 93 may move the clamp 3F in a crossing direction (a direction crossing the longitudinal direction of the electric cable 5) while the press member 42F is at a temporary stop. According to such a configuration, the clamp 3F is moved while the press member 42F is at a temporary stop. Therefore, it is easy to perform the control to match the timing at which the press member 42F is moved and the timing at which the clamp 3F is moved. For example, such a situation may be suppressed that the timing at which the clamp 3F is moved upward is not matched to the timing at which the press member 42F is moved and as a result, the upward movement of the clamp 3F starts after the press member 42F is moved to the end or before the press member 42F contacts the terminal 7.

There is no specific limitation on the material of the core wire 5a or the insulating member 5b of the electric cable 5. The core wire 5a may be formed of, for example, copper or aluminum. The electric cable 5 including an aluminum core wire tends to be elongated at the time of terminal crimping more significantly than the electric cable 5 including a copper core wire. Therefore, the terminal crimping device 8 according to the embodiments is particularly effective on the electric cable 5 including such an aluminum core wire 5a.

In the above-described embodiments, the terminal 7 is an open barrel terminal that allows the terminal 5 to be inserted thereto from above. There is no specific limitation on the type of the terminal 7. The terminal 7 may be a so-called closed barrel terminal.

In the above-described embodiments, the F-side clamp 3F and the R-side clamp 3R are respectively swung to move to positions facing the F-side crimper 4F and the R-side crimper 4R. However, there is no specific limitation on the manner of movement of the clamp 3F or 3R. For example, the F-side clamp 3F may slide in the left-right direction, without changing the orientation thereof, to move to a position facing the F-side crimper 4F. Similarly, the R-side clamp 3R may slide in the left-right direction, without changing the orientation thereof, to move to a position facing the R-side crimper 4R.

The gripping device gripping the electric cable 5 is not limited to the clamp 3F or 3R. The gripping device may be any device capable of gripping the electric cable 5, and is not limited to a device sandwiching the electric cable 5. The gripping device may be, for example, a device grasping the electric cable 5. Neither the gripping device, nor the moving device moving the electric cable 5 in a crossing direction crossing the longitudinal direction of the electric cable 5, is limited to a device drivable by an air cylinder. The gripping device and the moving device may each be a device using, for example, a hydraulic cylinder instead of an air cylinder. Alternatively, the gripping device and the moving device may each be a device using a motor, an electric actuator or the like.

### REFERENCE SIGNS LIST

1 Electric cable processing apparatus
3F, 3R Clamp (gripping device)
4F, 4R Crimper
5 Electric cable
6F, 6R Elevation device (moving device)
7 Terminal
8 Terminal crimping device
9 Controller
42F Press member
43F Actuator
91 Press controller (first controller)
92 Downward movement controller (third controller)
93 Upward movement controller (second controller)
94 Cancel controller (fourth controller)
P1 Top position (first position)
P2 Bottom position (second position)
P3 Intermediate position

1. A terminal crimping device, comprising:
a gripping device gripping an electric cable;
a crimper including a press member and an actuator driving the press member, the crimper crimping a terminal onto the electric cable, gripped by the gripping device, by use of the press member;
a moving device moving the gripping device in a crossing direction crossing a longitudinal direction of the electric cable; and
a controller controlling the gripping device, the crimper and the moving device, the controller including:
a first controller controlling the actuator to crimp the terminal onto the electric cable, and
a second controller driving the moving device to move the gripping device in the crossing direction during a time period after the press member contacts the terminal until the press member reaches a target position under the control of the first controller.

2. The terminal crimping device according to claim 1, wherein the crossing direction is substantially parallel to a driving direction of the press member.

3. The terminal crimping device according to claim 2, wherein the crossing direction is an upward direction or a downward direction.

4. The terminal crimping device according to claim 2, wherein:
where a direction in which the press member gets closer to the electric cable and the terminal is an approaching direction,
the moving device is capable of moving the gripping device to a first position and to a second position set to be further in the approaching direction than the first position,
the controller includes a third controller moving the gripping device from the first position to the second position along with the movement of the press member in the approaching direction under the control of the first controller, and
the second controller drives the moving device to move the gripping device from the second position to the first position during the time period after the press member contacts the terminal until the press member reaches the target position under the control of the first controller.

5. The terminal crimping device according to claim 2, wherein:
where a direction in which the press member gets closer to the electric cable and the terminal is an approaching direction,
the moving device is capable of moving the gripping device to a first position, to an intermediate position set to be further in the approaching direction than the first position, and to a second position set to be further in the approaching direction than the intermediate position,
the controller includes a third controller moving the gripping device from the first position to the second position along with the movement of the press member in the approaching direction under the control of the first controller, and
the second controller drives the moving device to move the gripping device from the second position to the intermediate position during the time period after the press member contacts the terminal until the press member reaches the target position under the control of the first controller.

6. The terminal crimping device according to claim 1, wherein:
the moving device is capable of putting the gripping device into a state of being movable in the crossing direction, and
the controller includes a fourth controller driving the moving device to putting the gripping device into a state of being movable in the crossing direction during a time period after the gripping device is moved in the crossing direction under the control of the second controller until the press member reaches the target position.

7. The terminal crimping device according to claim 1, wherein:
the first controller stops the press member temporarily during the time period after the press member contacts the terminal until the press member reaches the target position, and
the second controller moves the gripping device in the crossing direction while the press member is at a temporary stop.
